(19) United States
(12) Patent Application Publication
(10) Pub. No.: US 2018/0306115 A1
(43) Pub. Date: Oct. 25, 2018

(54) JET ENGINE WITH A COOLING DEVICE

(71) Applicant: Rolls-Royce Deutschland Ltd & Co KG, Blankenfelde-Mahlow (DE)

(72) Inventor: Sebastian MOTSCH, Ludwigsfelde (DE)

(21) Appl. No.: 15/958,182

(22) Filed: Apr. 20, 2018

(30) Foreign Application Priority Data
Apr. 21, 2017 (DE) 10 2017 108 597.1
Apr. 4, 2018 (EP) 18 165 730.5

(51) Int. Cl. F02C 7/18; F01D 5/08

(52) U.S. Cl. CPC F02C 7/18; F01D 5/081; F05D 2260/20; F05D 2220/323; F05D 2240/61; F01D 5/087

(57) ABSTRACT

A jet engine with a cooling device for cooling engine components and formed by a secondary air system, and with a central shaft that rotates about an engine axis during operation. A further cooling device is provided that includes a first fluid guiding channel extending coaxially to the central engine axis and configured for conducting cooling fluid in a first axial direction, a second fluid guiding channel radially surrounding the first fluid guiding channel and being configured for conducting cooling fluid in a second axial direction that is opposite to the first axial direction, and a deflection area for deflecting the cooling fluid from the first fluid guiding channel into the second fluid guiding channel or from the second fluid guiding channel into the first fluid guiding channel in an end area of the first fluid guiding channel and of the second fluid guiding channel.

This application claims priority to German Patent Application DE102017108597.1 filed Apr. 21, 2017, and European Application No. EP18165730.5 filed Apr. 4, 2018, the entirety of which is incorporated by reference herein.

The invention relates to a jet engine with a cooling device provided for cooling engine components according to the kind as it is more closely defined in the generic term of patent claim 1.

What is for example known from DE 690 18 338 T2 is a jet engine or aircraft engine in which, in addition to a primary air system that comprises an air conduction through a core flow channel and/or through a bypass channel, also a secondary air system is provided. Air is extracted from the primary air system air through the secondary air system, wherein the air of the secondary air system is in particular used for cooling engine components and/or for sealing bearing chambers.

Through the secondary air system, it is prevented that in particular highly loaded engine components are heated up to an undesired degree during operation of the jet engine, wherein a temperature gradient with a temperature minimum in the area of a central shaft is present in the interior of the jet engine during operation. In known jet engines, this temperature minimum in particular depends on the cooling air mass flows of the secondary air system. When it comes to the selection of maximally heat-resistant materials and cooling, the known methods of heat protection of engine components are subject to natural physics-based limits. The limits of these application ranges can be expanded only by means of costly measures.

The present invention is based on the objective of providing a jet engine in which the cooling of engine components is further improved in a constructionally simple manner.

According to the invention, this objective is achieved through a jet engine with the features of patent claim 1.

What is proposed is a jet engine with a cooling device that is provided for cooling engine components and that is formed by a secondary air system, as well as at least one rotating central shaft that rotates about a central engine axis during operation of the aircraft engine.

According to the invention, at least one further cooling device is provided, comprising a first fluid guiding channel that extends coaxially to the central engine axis and is configured for conducting cooling fluid in a first axial direction, a second fluid guiding channel that surrounds the first fluid guiding channel preferably radially outside or alternatively also inside and that is configured for conducting cooling fluid in a direction that is opposite to the first axial direction. Further, this further cooling device comprises a deflection area for deflecting the cooling fluid from the first fluid guiding channel into the second fluid guiding channel or from the second fluid guiding channel into the first fluid guiding channel in an end area of the first fluid guiding channel and of the second fluid guiding channel.

By providing the further cooling device with the guidance of cooling fluid in two opposite directions, an improved cooling or an improved cooling efficiency of engine components can be achieved, which can be realized in a simple and cost-effective manner. Thanks to the further cooling device, a temperature level in particular in the area of the central shaft can be significantly lowered during operation of the jet engine as compared to conventionally designed jet engines and an additional thermal sink can be created, so that less heat-resistant and thus more cost-effective materials can be used for engine components and/or a lower weight of the respective engine component can be achieved as compared to conventionally designed jet engines.

As a result of the improved cooling according to the invention, a longer service life of engine components, in particular with respect to corrosion and damage tolerance, can also be obtained.

The further cooling device can be embodied so as to be decoupled from the secondary air system, which in addition to cooling usually also serves for sealing and/or bearing load control, and in particular forms a further air system that is independent of the secondary air system, quasi a tertiary air system that does not influence or compromise the pressure and flow developments of the secondary air system as the flow passes the at least one central shaft. This can be achieved in a simple manner by a pressure being present inside the first fluid guiding channel and/or the second fluid guiding channel which substantially corresponds to an ambient pressure during operation of the jet engine. Thus, the further cooling device can be integrated into existing engine concepts in a simple manner.

For reasons of practicability, what primarily comes into question as the cooling fluid in jet engines of an aircraft is a gas, and here in particular air. However, in addition it is also conceivable that a cooling liquid is used.

In principle, the jet engine embodied according to the invention can be embodied as a single-shaft engine or as a multi-shaft engine that has one or further central shafts that are preferably made of a material with a high thermal conductivity. The fluid guiding channels are guided through cavities of these shafts, wherein the fluid guiding channels are preferably embodied with a diameter that is as large as possible, so that the respective fluid guiding channel has a large surface or wall surface.

In an advantageous embodiment of a jet engine according to the invention, two central shafts are provided, of which one is embodied as an inner hollow shaft and the other as an outer hollow shaft that is arranged coaxially to the inner hollow shaft and surrounds the same, wherein the first fluid guiding channel extends inside the inner hollow shaft and the second fluid guiding channel extends between the inner hollow shaft and the outer hollow shaft. Here, the first fluid guiding channel is separated from the second guiding channel only by a wall of the inner central shaft.

The central shafts can in particular be embodied as a shaft in the low-pressure area, as a shaft in the medium-pressure area and/or as a shaft in the high-pressure area of the jet engine, wherein the inner hollow shaft can also be realized as a so-called air guide tube that is arranged inside a shaft. Thus, there are varied possibilities of integrating the further cooling device according to the invention in known engine concepts.

In a preferable embodiment of the jet engine according to the invention, the outer hollow shaft has a closed end area in the deflection area. Here, a deflection of cooling fluid from the first fluid guiding channel into the second fluid guiding channel or vice versa is created in an expedient manner if the inner hollow shaft is shorter in the deflection area in the axial direction of the jet engine than the outer hollow shaft of the jet engine and is enclosed by the same in the deflection area.

A fluid inlet for supplying cooling fluid into the first fluid guiding channel or into the second fluid guiding channel and a fluid outlet for draining cooling fluid from the second fluid guiding channel or from the first fluid guiding channel is necessary, wherein the fluid inlet and the fluid outlet are advantageously respectively arranged in an end area of the fluid guiding channels that is facing upstream or that is facing downstream in the main flow direction of the aircraft engine. During operation of the jet engine, ambient air can for example be supplied to the fluid guiding channels through an opening arranged in the area of a nose cone.

With a view to the positioning of the cavities of the hollow shafts and a simple supply of cooling fluid it is advantageous if the fluid inlet is arranged in an area of the jet engine that is central with respect to the radial direction of the aircraft engine.

In order to create an improved cooling fluid supply through the fluid inlet into the first fluid guiding channel or into the second fluid guiding channel, a cooling fluid conveying appliance can be arranged in the area of the fluid inlet. The cooling fluid conveying appliance can for example be embodied as an external compressor that is arranged outside of the fluid guiding channels and/or as a compressor that is arranged inside a fluid guiding channel and that is for example realized as a microcompressor. At that, vanes, in particular so-called scoops, can be circumferentially arranged in an area of the fluid guiding channel that is facing towards the fluid inlet.

In addition to the provision of a cooling fluid conveying appliance, it can also be provided that cooling fluid is supplied to the fluid guiding channel passively as a result of a pressure gradient that is present during operation. Further, it is also conceivable that, for example in an operating state of an aircraft that is referred to as taxi or take off, cooling fluid is supplied to the fluid guiding channel in an active manner by means of a cooling fluid conveying appliance, and that it is supplied in a passive manner by means of convection during a flight.

To increase the heat conversion in the area of the fluid guiding channels and to improve the cooling of air mass flows of the secondary air system, at least one fluid guiding channel can have means for flow guidance inside the fluid guiding channel at a radially inner surface and/or a radially outer surface at least in certain areas, with the means for flow guidance being in particular formed by a corresponding contouring of the fluid guiding channel. Such means can be embodied for the purpose of applying a swirl to a cooling fluid flow guided through the fluid guiding channel, so that thermal energy conversion is increased in this manner. Through an interaction of the cooling fluid guided through the fluid guiding channel with air mass flows of the secondary air system, also an improved cooling of the air mass flows of the secondary air system can be achieved.

In an advantageous embodiment of a jet engine according to the invention, the first fluid guiding channel and/or the second fluid guiding channel extends in the axial direction of the jet engine from an area upstream of a fan up to an area downstream of a turbine appliance, for example inside an exhaust plug, wherein the deflection area is in particular provided in the area of the exhaust plug.

In order to separate a cooling fluid flow in the area of a cooling fluid entry into a fluid guiding channel from a cooling fluid flow in the area of a cooling fluid exit out of the other fluid guiding channel in a simple manner, at least one deflection appliance for guiding the cooling fluid outwards in the radial direction, in particular in the direction of a bypass channel of the aircraft engine, can be arranged in the area of the fluid outlet.

The features specified in the patent claims as well as the features specified in the following exemplary embodiment of the jet engine according to the invention are suitable to further develop the subject matter according to the invention respectively on their own or in any desired combination with each other.

Further advantages and advantageous embodiments of the of the jet engine according to the invention follow from the patent claims and from the exemplary embodiment that is described in principle in the following by referring to the drawing.

Herein:

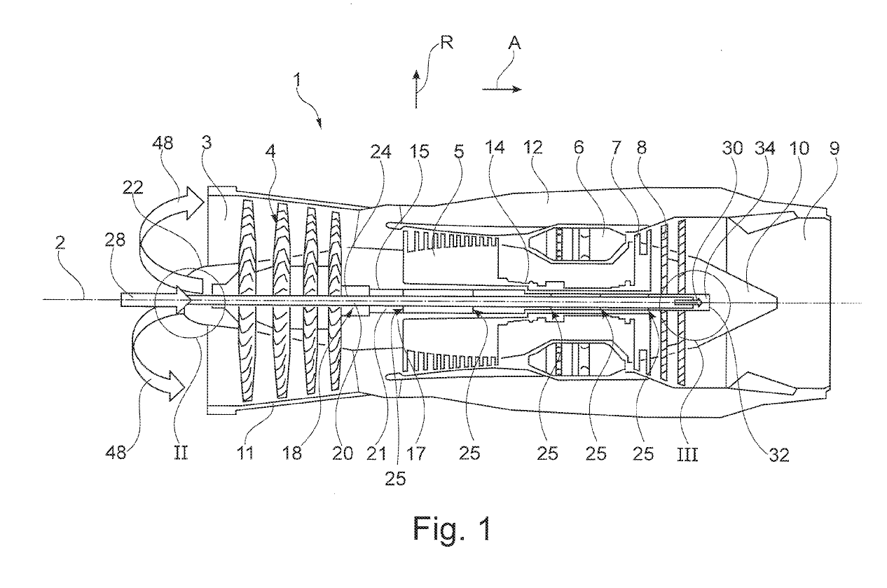

FIG. 1 shows a simplified sectional view of a jet engine with a cooling device formed by a secondary air system and a further cooling device arranged inside axially central hollow shafts;

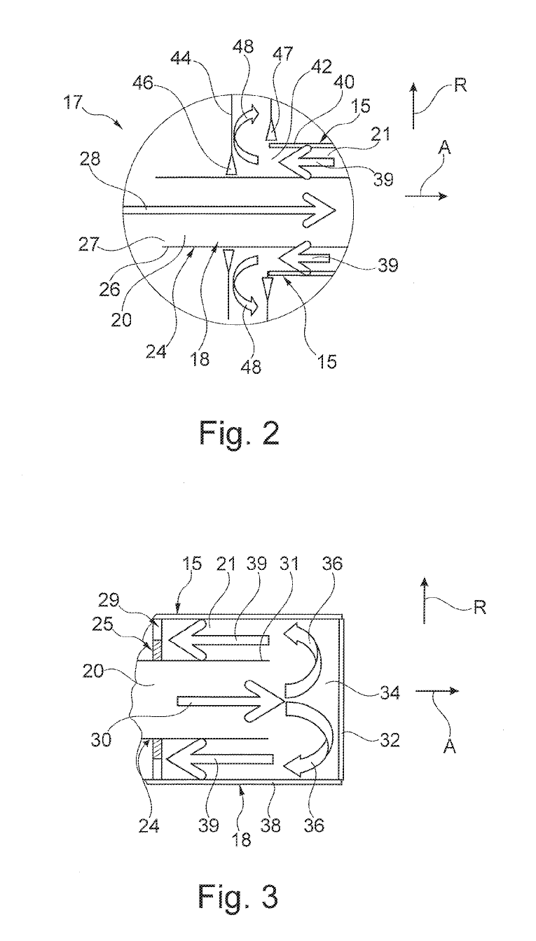

FIG. 2 shows a strongly schematized rendering of an area that is indicated by a circle II in FIG. 1;

FIG. 3 shows a strongly schematized rendering of an area that is indicated by a circle III in FIG. 1; and

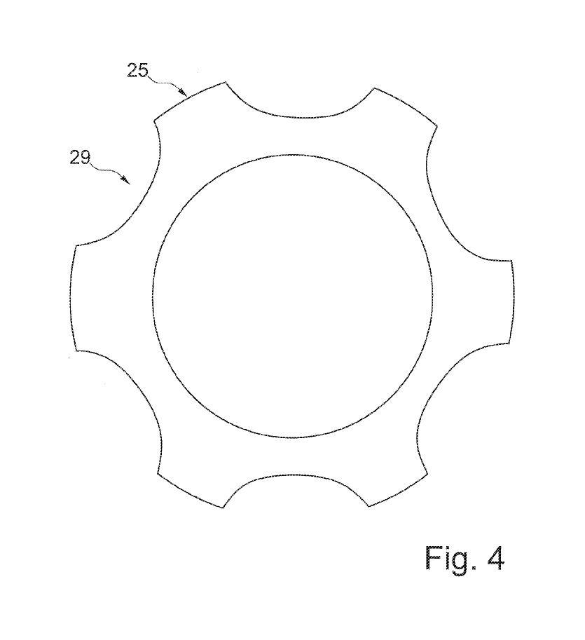

FIG. 4 shows a simplified front view of a radial support appliance illustrated in FIG. 1 and FIG. 3.

FIG. 1 shows a jet engine 1 of an aircraft that has a central main rotational axis 2. Further, the jet engine 1 comprises in the axial flow direction an air intake 3, in this case multiple fans 4, a compressor 5, a combustion appliance 6, a high-pressure turbine 7, a low-pressure turbine 8, and a discharge nozzle 9, with an exhaust plug 10 being arranged in its area. An engine nacelle 11 surrounds the gas turbine engine 1 and delimits the air intake 3.

The jet engine 1 operates in a conventional manner, wherein air entering the air intake 3 is accelerated by the fan 4 to create two air flows. A first air flow flows into the compressor 5 that compresses the air flow that is supplied to it, and a second air flow is passed through a bypass channel 12 to provide a drive thrust.

The compressed air that is discharged from the compressor 5 is introduced into the combustion appliance 6, where an intermixing with fuel occurs, and the fuel-air mixture is combusted. The resulting hot combustion products expand and in doing so drive the high-pressure turbine 7 and the low-pressure turbine 8, before they are discharged via the discharge nozzle 9 to provide additional drive thrust. The high-pressure turbine 7 and the low-pressure turbine 8 respectively drive the compressor 5 or the fan 4 via a high-pressure shaft 14 or a low-pressure shaft 15.

For cooling the engine components, a cooling device 17 formed by the secondary air system is provided, with the cooling device 17 being of a conventional type and being indicated only symbolically in FIG. 1. In addition, a further cooling device 18 representing a tertiary air system is provided, which in the present case is separated from the secondary air system, so that cooling air that is guided in the area of the further cooling device 18 does not pass over into the cooling device 17 forming the secondary air system or vice versa, and the secondary air cooling device 17 and the tertiary air cooling device 18 form separate cooling devices.

The further cooling device 18 has a first fluid guiding channel 20 or air conduction channel and a second fluid guiding channel 21 or air conduction channel that respectively extend in the axial direction A of the jet engine, in the present case from an area of a nose cone 22 up to an area inside the exhaust plug 10. The fluid guiding channels 20, 21, are formed inside the cavities of a central shaft 24 forming an inner hollow shaft and representing a so-called air guide tube and of the low-pressure shaft 15 surrounding the inner hollow shaft and forming an outer hollow shaft.

The first fluid guiding channel 20 is formed by a central bore of the air guide tube or inner hollow shaft 24 and, in an end area 26 that is located upstream with respect to a main flow direction A, has a fluid inlet 27 or air intake that can be seen in more detail in FIG. 2 and via which air, which is symbolized by an arrow 28, can be supplied to the first fluid guiding channel 20 from the environment during operation. In order to facilitate a corresponding air supply, the structural components arranged upstream of the air intake 27, for example the nose cone 22 arranged in a central area, have a correspondingly dimensioned opening.

The second fluid guiding channel 21 is formed outside of the wall area of the inner hollow shaft 24, as viewed in the radial direction R of the jet engine 1, inside a remaining annular space opposite a wall area of the low-pressure shaft or the outer hollow shaft 15.

The first fluid guiding channel 20 and the second fluid guiding channel 21 can be radially stabilized across their axial extension by means of at least one radial support appliance 25. In this manner, the observance of a defined radial distance between the inner side of the outer hollow shaft 15 and the outer side of the inner hollow shaft 24 can be ensured, and relative movements, which in the most unfavorable case can even lead to the hollow shafts knocking against each other or bending in an uncontrolled manner, can be avoided. In the shown embodiment, multiple support points are arranged for this purpose across the longitudinal extension inside the outer second fluid guiding channel 21, with respectively one support ring 25 as the support appliance, which is shown in FIG. 4 in more detail. The support rings 25 extend between the inner side of the outer hollow shaft 15 and the outer side of the inner hollow shaft 24 and have air passage openings 29. In the present case, the air passage openings 29 are formed as segment-like recesses at the outer radius. However, they can also be provided to be hole-like or to have any other geometry and number by which the air passage is obstructed as little as possible. The number of support rings 25 and their distance to each other across the longitudinal extension of the hollow shafts 15, 24 can vary depending on the design of the engine and of its performance level.

Air that is supplied via the air intake 27 to the first fluid guiding channel 20 is guided according to the arrow 30 in the main flow direction A to a downstream end area 31 of the first fluid guiding channel, which is shown in an enlarged manner in FIG. 3. Via a deflection area 32, which here is formed by a closed-off end 34 of the second fluid guiding channel 21, the air is deflected according to the arrows 36 into an end area 38 of the second fluid guiding channel 21, so that the air flows in the second fluid guiding channel 21 according to the arrows 39 counter to the main flow direction A and counter to the flow direction inside the first fluid guiding channel 20 until it is discharged through an fluid outlet 42 or air outlet in an upstream end area 40 of the second fluid guiding channel 21.

Arranged in the area of the fluid outlet 42 is a deflection appliance 44 that forms a part of the fluid guiding channel is arranged and by means of which the air that is guided through the second fluid guiding channel 21 is deflected according to the arrows 48, in the present case in a substantially radial direction R outwards, for example in the direction of the bypass channel 12, and is supplied to the same. In this way, an undesired interaction of the air that is discharged through the fluid outlet 42 with the air that is introduced through the fluid inlet 27 is avoided in a simple manner. Here, respectively one sealing appliance 46, 47 is arranged in an area that adjoins the first fluid guiding channel 20 and in an area that adjoins the second fluid guiding channel 21.

In the present case, the fluid guiding channels 20, 21 are designed in such a manner that a pressure substantially corresponding to the ambient pressure is present in the first fluid guiding channel 20 and the second fluid guiding channel 21 during operation of the jet engine 1, in particular across the entire operating range of the jet engine 1.

In the shown above-described embodiment, in particular engine components adjoining the low-pressure shaft 15 are additionally cooled by the cooling of the secondary air system during operation of the jet engine 1 thanks to further cooling device 18, so that advantageously low temperatures are present in their area during operation of the jet engine 1.

### Parts List

1 jet engine
2 main rotational axis
3 air intake
4 fan
5 compressor
6 combustion appliance
7 high-pressure turbine
8 low-pressure turbine
9 discharge nozzle
10 exhaust plug
11 engine nacelle
12 bypass channel
14 high-pressure shaft
15 low-pressure shaft, outer hollow shaft
17 cooling device, secondary air system
18 further cooling device
20 first fluid guiding channel
21 second fluid guiding channel
22 nose cone
24 central shaft, inner hollow shaft
25 radial support appliance
26 upstream end area radial support appliance of the first fluid guiding channel
27 fluid inlet
28 arrow air conduction
29 air passage opening
30 arrow air conduction
31 downstream end area of the first fluid guiding channel
32 deflection area
34 closed-off end of the second fluid guiding channel
36 arrow air conduction
38 downstream end area of the second fluid guiding channel
39 arrow air conduction
40 upstream end area of the second fluid guiding channel
42 fluid outlet
44 deflection appliance; fluid guiding channel
46, 47 sealing appliance
48 arrow air conduction
A axial direction, main flow direction
R radial direction of the jet engine

1. A jet engine with a cooling device provided for cooling engine components and formed by a secondary air system, and with at least one central shaft that rotates about a central engine axis during operation of the jet engine, wherein at least one further cooling device is provided that comprises
a first fluid guiding channel that extends coaxially to the central engine axis and is configured for conducting cooling fluid in a first axial direction,
a second fluid guiding channel that radially surrounds the first fluid guiding channel and is configured for conducting cooling fluid in a direction that is opposite to the first axial direction, and
a deflection area for deflecting the cooling fluid from the first fluid guiding channel into the second fluid guiding channel or from the second fluid guiding channel into the first fluid guiding channel in an end area of the first fluid guiding channel and of the second fluid guiding channel.

2. The jet engine according to claim 1, wherein two central shafts are provided, of which one is embodied as an inner hollow shaft and the other as an outer hollow shaft that is arranged coaxially to the inner hollow shaft and surrounds the same, wherein the first fluid guiding channel extends inside the inner hollow shaft and the second fluid guiding channel extends between the inner hollow shaft and the outer hollow shaft.

3. The jet engine according to claim 2, wherein the outer hollow shaft has a closed-off end in the deflection area.

4. The jet engine according to claim 1, wherein a fluid inlet is provided for supplying cooling fluid into the first fluid guiding channel or the second fluid guiding channel and a fluid outlet is provided for draining cooling fluid from the second fluid guiding channel or the first fluid guiding channel, wherein the fluid inlet and the fluid outlet are arranged in an end area of the fluid guiding channels that is facing upstream or is facing downstream in the main flow direction of the jet engine.

5. The jet engine according to claim 4, wherein the fluid inlet is arranged in an area of the jet engine that is central with respect to the radial direction of the jet engine.

6. The jet engine according to claim 1, wherein a cooling fluid conveying appliance is arranged in the area of the fluid inlet.

7. The jet engine according to claim 1, wherein at least one fluid guiding channel has means for flow guidance inside the fluid guiding channel at least in certain areas.

8. The jet engine according to claim 1, wherein the first fluid guiding channel and/or the second fluid guiding channel extend in the axial direction of the jet engine from an area upstream of a fan up to an area downstream of a turbine appliance.

9. The jet engine according to claim 1, wherein at least one deflection appliance for guiding the cooling fluid in the radial direction outwards is arranged in the area of the fluid outlet.

10. The jet engine according to claim 1, wherein the cooling fluid is cooling air.
